(19) United States
(12) Patent Application Publication
(10) Pub. No.: US 2026/0081660 A1
(43) Pub. Date: Mar. 19, 2026

(54) CHANNEL STATE INFORMATION FEEDBACK COMPRESSION IN NEW RADIO TRANSMISSION

(71) Applicant: TOYOTA JIDOSHA KABUSHIKI KAISHA, Toyota-shi, Aichi-ken (JP)

(72) Inventor: Shao-Yu LIEN, Tainan City (TW)

(73) Assignee: TOYOTA JIDOSHA KABUSHIKI KAISHA, Toyota-shi, Aichi-ken (JP)

(21) Appl. No.: 19/107,417

(22) PCT Filed: Aug. 3, 2023
(86) PCT No.: PCT/JP2023/028490

§ 371 Date: Feb. 27, 2025

Related U.S. Application Data
(60) Provisional application No. 63/373,985, filed on Aug. 30, 2022.

(51) Int. Cl. H04B 7/06; H04L 25/02; H04L 41/16

(52) U.S. Cl. CPC H04B 7/0626; H04L 25/0202; H04L 41/16

(57) ABSTRACT

The present disclosure includes a method for managing channel state information feedback compression in user equipment. The method includes: receiving at least one reference signal; estimating a channel condition based on the at least one reference signal; reducing, using a first autoencoder encoder in user equipment (UE), a dimension of the estimated channel condition such that a low dimension channel condition is generated; calculating, using a second autoencoder encoder and an autoencoder decoder in the UE, an error measurement based on a difference between UE channel state input and UE channel state output; and transmitting at least one of a channel state information bit stream or at least one message, wherein the at least one of the channel state information bit stream or the at least one message is based on at least one of the low dimension channel condition or a value indicative of the error measurement.

### CROSS REFERENCES TO RELATED APPLICATIONS

This application is a National Phase of International Application No. PCT/JP2023/028490, filed on Aug. 3, 2023, which claims the benefit of priority of U.S. Provisional Patent Application No. 63/373,985 , filed on Aug. 30, 2022, entitled “CHANNEL STATE INFORMATION FEEDBACK COMPRESSION IN NEW RADIO TRANSMISSIONS”, the entire contents of both of which are incorporated herein by reference.

### TECHNICAL FIELD

Apparatuses and methods consistent with the present disclosure relate generally to communications, more specifically, methods, systems, and devices for channel state information (CSI) reporting in a wireless network.

### BACKGROUND

CSI provides information about the state of a wireless channel between a base station (gNB) and user equipment (UE). This information is crucial for various tasks, such as beamforming, power control, and scheduling, in order to optimize the performance of a wireless network. CSI may include one or more parameters, such as, channel quality, signal strength, interference levels, and other relevant metrics to provide for efficient communication between the base station and UE.

In 3GPP New Radio (NR), a challenge may exist in precisely describing a channel condition. For example, communicating a channel condition when the dimension of the channel condition is high may require a high number of bits.

### SUMMARY

In view of the foregoing, embodiments of the present disclosure address disadvantages of existing systems by providing apparatuses, systems and methods for CSI reporting in a wireless network.

According to some embodiments of the present disclosure, there is provided a method for managing CSI feedback compression in UE. The method includes: receiving at least one reference signal; estimating a channel condition based on the at least one reference signal; reducing, using a first autoencoder encoder in UE, a dimension of the estimated channel condition such that a low dimension channel condition is generated; calculating, using a second autoencoder encoder and an autoencoder decoder in the UE, an error measurement based on a difference between UE channel state input and UE channel state output; and transmitting at least one of a CSI bit stream or at least one message, wherein the at least one of the CSI bit stream or the at least one message is based on at least one of the low dimension channel condition or a value indicative of the error measurement.

According to some embodiments of the present disclosure, there is provided an apparatus for CSI feedback compression. The apparatus includes a memory storing an instruction; and a processor configured to execute the instruction stored in the memory to: receive at least one reference signal; estimate a channel condition based on the at least one reference signal; reduce, using a first autoencoder encoder in UE, a dimension of the estimated channel condition such that a low dimension channel condition is generated; calculate, using a second autoencoder encoder and an autoencoder decoder in the UE, an error measurement based on a difference between UE channel state input and UE channel state output; and transmit at least one of a CSI bit stream or at least one message, wherein the at least one of the CSI bit stream or the at least one message is based on at least one of the low dimension channel condition or a value indicative of the error measurement.

According to some embodiments of the present disclosure, there is provided a non-transitory computer-readable medium storing instructions that are executable by one or more processors of an apparatus for managing CSI feedback compression, to perform a method. The method includes: receiving at least one reference signal; estimating a channel condition based on the at least one reference signal; reducing, using a first autoencoder encoder in UE, a dimension of the estimated channel condition such that a low dimension channel condition is generated; calculating, using a second autoencoder encoder and an autoencoder decoder in the UE, an error measurement based on a difference between UE channel state input and UE channel state output; and transmitting at least one of a CSI bit stream or at least one message, wherein the at least one of the CSI bit stream or the at least one message is based on at least one of the low dimension channel condition or a value indicative of the error measurement.

According to some embodiments of the present disclosure, there is provided a method for managing CSI feedback compression. The method includes: transmitting at least one reference signal; receiving at least one of a CSI bit stream in response to the transmitted at least one reference signal, or at least one message; determining at least one of a low dimension channel condition or a value indicative of an error measurement based on the at least one of the CSI bit stream or the at least one message; calculating at least one of updated weights or updated parameters for an autoencoder decoder in a base station based on at least one of an estimated channel condition or the value indicative of the error measurement, wherein the estimated channel condition is based on the low dimension channel condition; and updating at least one of weights or parameters of the autoencoder decoder in the base station based on the calculated at least one of updated weights or updated parameters.

According to some embodiments of the present disclosure, there is provided an apparatus for managing CSI feedback compression. The apparatus includes a memory storing an instruction; and a processor configured to execute the instruction stored in the memory to: transmit at least one reference signal; receive at least one of a CSI bit stream in response to the transmitted at least one reference signal or at least one message; determine at least one of a low dimension channel condition or a value indicative of an error measurement based on the at least one of the CSI bit stream or the at least one message; calculate at least one of updated weights or updated parameters for an autoencoder decoder in a base station based on at least one of an estimated channel condition or the value indicative of the error measurement, wherein the estimated channel condition is based on the low dimension channel condition; and update at least one of weights or parameters of the autoencoder decoder in the base station based on the calculated at least one of updated weights or updated parameters.

According to some embodiments of the present disclosure, there is provided a non-transitory computer-readable medium storing instructions that are executable by one or more processors of an apparatus for managing CSI feedback compression, to perform a method. The method includes: transmitting at least one reference signal; receiving at least one of a CSI bit stream in response to the transmitted at least one reference signal or at least one message; determining at least one of a low dimension channel condition or a value indicative of an error measurement based on the at least one of the CSI bit stream or the at least one message; calculating at least one of updated weights or updated parameters for an autoencoder decoder in a base station based on at least one of an estimated channel condition or the value indicative of the error measurement, wherein the estimated channel condition is based on the low dimension channel condition; and updating at least one of weights or parameters of the autoencoder decoder in the base station based on the calculated at least one of updated weights or updated parameters.

According to some embodiments of the present disclosure, there is provided a method for managing CSI feedback compression in UE. The method includes: receiving at least one reference signal; estimating a channel condition based on the at least one reference signal; reducing, using a first autoencoder encoder in UE, a dimension of the estimated channel condition such that a low dimension channel condition is generated; calculating, using a second autoencoder encoder and an autoencoder decoder in the UE, an error measurement based on a difference between UE channel state input and UE channel state output; calculating at least one of updated weights or updated parameters for the first autoencoder encoder in the UE based on a value indicative of the error measurement; updating at least one of weights or parameters of the first autoencoder encoder in the UE based on the calculated at least one of updated weights or updated parameters; generating at least one of a CSI bit stream or at least one message based on the at least one of the low dimension channel condition or at least one of updated weights or updated parameters of the first autoencoder encoder in the UE; and transmitting the at least one of the CSI bit stream or the at least one message.

According to some embodiments of the present disclosure, there is provided a method for managing CSI feedback compression in a base station. The method includes: transmitting at least one reference signal; receiving at least one of a CSI bit stream in response to the transmitted at least one reference signal, or at least one message; determining at least one of updated weights, updated parameters, or structure for at least one of a first autoencoder in a UE, a second autoencoder in the UE or an autoencoder decoder in the UE; calculating at least one of updated weights or updated parameters for an autoencoder decoder in a base station based on the at least one of the updated weights or the updated parameters for the autoencoder encoder in the UE; and updating at least one of weights, parameters or structure of the autoencoder decoder in the base station based on the calculated at least one of updated weights or updated parameters or structure.

Some embodiments of the present disclosure involve receiving at least weights, parameters, or structure of at least a first autoencoder encoder, a second autoencoder encoder, and/or an autoencoder decoder in a UE from a base station; updating at least the weights, parameters, or structure(s) of at least the first autoencoder encoder, the second autoencoder encoder, and/or the autoencoder decoder in the UE using the weights, parameters, or structure received from the base station.

Some embodiments of the present disclosure involve calculating and/or updating, in a base station, at least one of weights, parameters or structure(s) of at least one of a first autoencoder decoder, a second autoencoder decoder, and/or an autoencoder encoder; and transmitting the weights, parameters or structure to a UE.

### BRIEF DESCRIPTION OF DRAWINGS

FIG. 1 is a schematic diagram illustrating an example of CSI feedback for downlink (DL) and uplink (UL) transmissions.

FIG. 2 is a schematic diagram illustrating an example of basic architecture of an autoencoder.

FIG. 3 is a schematic diagram illustrating an example of basic architecture of an autoencoder and associated training on dataset to determine weights/parameters of an encoder and decoder.

FIG. 4 is a schematic diagram illustrating an example of sandwich structure of an autoencoder, in which structures of an encoder and decoder are symmetric.

FIG. 5 is a schematic diagram illustrating an example of general architecture using an autoencoder for CSI compression.

FIG. 6 is a schematic diagram illustrating an example of updating structures of an autoencoder encoder and an autoencoder decoder, weights/parameters for the autoencoder encoder and autoencoder decoder and CSI bitstream generation and decoding schemes.

FIG. 7 is a flowchart illustrating an exemplary method for managing CSI feedback compression, e.g., in UE, according to embodiments of the present disclosure.

FIG. 8 presents a flowchart illustrating another exemplary method for managing CSI feedback compression, e, g., in a base station, according to embodiments of the present disclosure.

FIG. 9 is a schematic diagram illustrating an example of updating structures of an autoencoder encoder and an autoencoder decoder, the weights/parameters for the autoencoder encoder and autoencoder decoder and the CSI bitstream generation and decoding schemes.

FIG. 10 is a flowchart illustrating a further exemplary method for managing CSI feedback compression, e.g., in UE, according to embodiments of the present disclosure.

FIG. 11 is a flowchart illustrating an additional exemplary method for managing CSI feedback compression in a gNB, according to embodiments of the present disclosure.

FIG. 12 is a block diagram of a device, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

In 3GPP NR, the radio resource allocations, configurations and transmission schemes on the Uu interface (the interface between a UE and a gNB) are determined by the base station. To optimize the performance in different aspects on the Uu interface, the base station may dynamically adjust the radio resource allocations, configurations and transmission schemes based on the present channel condition on the Uu interface. To this end, the base station may be aware of the present channel condition on the Uu interface, both in the DL and UL transmissions. The dimension of the channel condition as reported in CSI may be high and it may be a challenge to precisely describe the channel condition. For example, communicating the channel condition when the dimension of the channel condition is high may involve a high number of bits. To address the issue of describing the channel condition precisely using CSI feedback, one approach may include using a smaller number of bits to report the channel condition through the CSI, e.g., using CSI compression.

A second issue in reporting the channel condition via CSI feedback may include presenting the channel condition more precisely (i.e., with a higher accuracy), in other words accuracy enhancement of CSI reporting. At least some embodiments disclosed herein provide approaches to address the issue of CSI compression. Further, at least some disclosed embodiments provide approaches to present the channel condition more precisely.

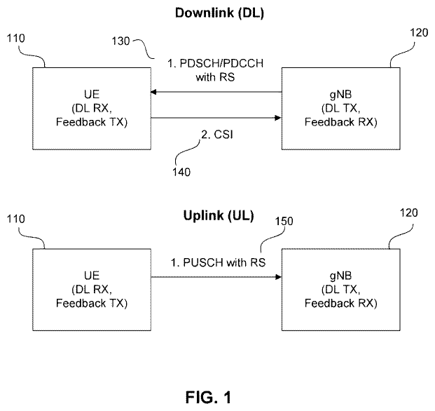

FIG. 1 is a schematic diagram illustrating CSI feedback for DL and UL transmissions. In 3GPP NR, CSI feedback may only be used for DL transmission. In DL transmissions, a base station 120 is the transmitter (TX) and a UE 110 is the receiver (RX) of downlink traffic. To estimate the channel condition in downlink transmissions, in 3GPP NR, the base station 120 transmits reference signal RS 130 on the physical downlink shared channel (PDSCH) and physical downlink control channel (PDCCH), as illustrated in FIG. 1, where the sequences and formats of reference signal RS 130 have been provided in standards of 3GPP NR. In response to receiving the reference signal RS 130, the UE 110 may estimate the downlink channel condition based on the distortion of the received reference signal RS 130. Subsequently, UE 110 may provide the base station 120 with information associated with the downlink channel condition by sending CSI 140 to the base station 120 (i.e., provide CSI feedback). The contents of channel state information 140 in 3GPP NR may include Channel Quality Indicator (CQI), Precoding Matrix Indicator (PMI), CSI-RS Resource Indicator (CRI), Synchronization Signal and Physical Broadcast Channel Resource Block Indicator (SSBRI), Layer Indicator (LI) and Rank Indicator (RI). In uplink transmissions, UE 110 is the transmitter (TX) and the base station 120 is the receiver (RX) of uplink traffic. To estimate the channel condition in uplink transmissions, the UE 110 may also transmit reference signal RS 150 (RSs on the physical uplink shared channel (PUSCH)). Upon receiving reference signal RS 150, the base station 120 may estimate the uplink channel conditions based on the distortion of the reference signal RS 150. In the uplink case, the base station 120 may not send the CSI to UE 110.

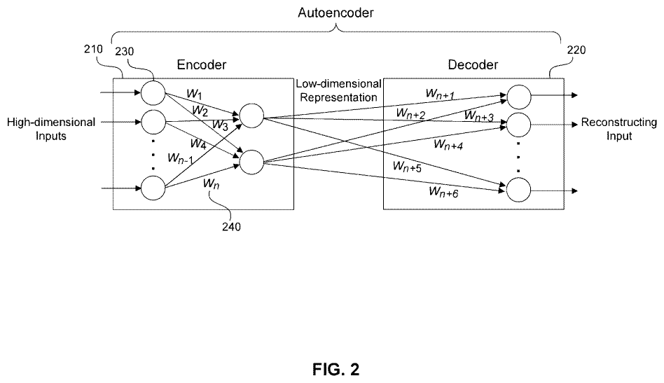

FIG. 2 is a schematic diagram illustrating an example of the basic architecture of an autoencoder. An autoencoder may be a type of artificial neural network that may be used for dimensionality reduction. The autoencoder may include an encoder and a decoder. The encoder may take input data and compress it into a lower-dimensional representation. The decoder may then take the compressed representation and reconstruct the original input data. Consistent with some disclosed embodiments, an autoencoder may be used to reduce the dimension of the CSI. An autoencoder composed of an encoder and a decoder may relate to unsupervised learning methods based on deep neural networks. As illustrated in FIG. 2, both the encoder 210 and the decoder 220 may be composed of a number of neural nodes 230 belonging to different operation stages, where the neural nodes 230 belonging to the same operation stage form a layer. There may be a number of links connecting the neural nodes in different layers, and each link may be multiplied by a weight/parameter 240. At each neural node 230, a non-linear operation (e.g., sigmoid function, step function, etc.) may be applied to all the inputs (multiplied by the corresponding weights/parameters 240) to generate the output. Prior to the output of neural node 230 becoming the input of the neural node 230 in the next layer, the output may be multiplied by the corresponding weight/parameter 240.

The input of the encoder 210 may be of a high dimension, and the purpose of encoder 210 may be to reduce the dimension of the input. The output of encoder 210 may consequently be a low-dimensional representation of the input of encoder 210, and the output of encoder 210 then becomes the input of decoder 220. The purpose of decoder 220 may be to reconstruct the low-dimensional input as the high-dimensional output. It may be expected that the output of the decoder 220 and the input of the encoder 210 may be identical.

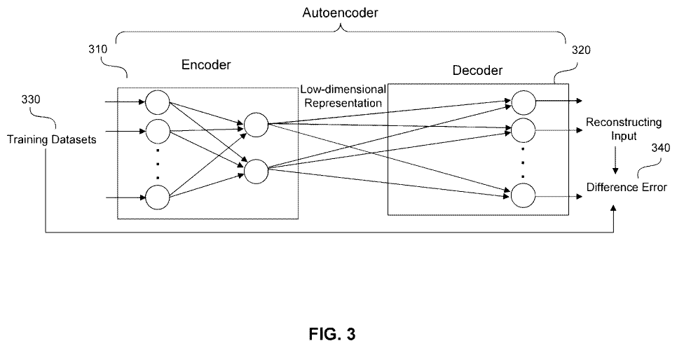

FIG. 3 is a schematic diagram illustrating an example of the basic architecture of an autoencoder and associated training on a dataset 330 to determine weights/parameters of encoder 310 and decoder 320. A dataset 330 for an autoencoder may refer to the collection of input data that may be used to train and evaluate the autoencoder model. In the context of the autoencoder, the dataset 330 may include a set of unlabeled examples or samples that the autoencoder may learn to reconstruct. To make the input of encoder 310 and the output of decoder 320 identical, the weights/parameters in encoder 310 and in decoder 320 may be adequately updated for any arbitrary input of the autoencoder. When the weights/parameters in encoder 310 and in decoder 320 may not be adequate based on the present input of the autoencoder, certain differences or errors 340 between the input of the encoder 310 and the output of the decoder 320 may be measured in terms of a certain form of loss function (e.g., mean square error, root mean square error, normalized mean square error, etc.), as illustrated in FIG. 3. Subsequently, the weights/parameters in encoder 310 and in decoder 320 may be updated based on the present differences or errors 340. It is to be appreciated that the input of encoder 310 and the output of decoder 320 may be identical, nearly identical, similar or any other correlation between the two that may result from training or operation use. The goal may be that they are identical, but it is to be appreciated that they may not match in some cases. For example, the differences or errors 340 may represent a deviation between the input of encoder 310 and the output of decoder 320.

To make the input of the encoder and the output of the decoder identical, the weights and parameters in both the encoder and decoder may be adequately updated for any arbitrary input of the autoencoder. In applications where an autoencoder may be used, many structures of the autoencoder have been proposed. The structure of an autoencoder may be specified based on the several characteristics including, but not limited to, the number of layers and the number of neural nodes in each layer. Returning to the example illustrated in FIG. 2, the encoder 210 shown may have two layers and the second layer may have two neural nodes. The structure of the autoencoder may have different types of layers. For example, the autoencoder may include pooling layers, convolution layers and the like. The connection architecture between layers may include partially connected, fully connected or any other connectivity between nodes and/or layers that may be determined based on the application. Further, the structure of the autoencoder may include different types of connections including forward connections, backwards connections and the like.

In an autoencoder structure, a neural node may implement different types of operations. For example, the neural node may implement a sigmoid function, a step function or other similar data manipulation operations. The structure of the autoencoder may determine the number of weights/parameters in the encoder and in the decoder. For example, as illustrated in FIG. 2, the encoder may have Wₙ weights 240 based on the structure determined for the autoencoder. The autoencoder structure may determine the types of weights/parameters 240 in the implementation. For example, the weights/parameters 240 may include real numbers, complex numbers, integer numbers, floating numbers or any other data type that may be dictated by the structure of the autoencoder. The autoencoder structure selected for the application may determine what loss functions may be used to measure differences or errors.

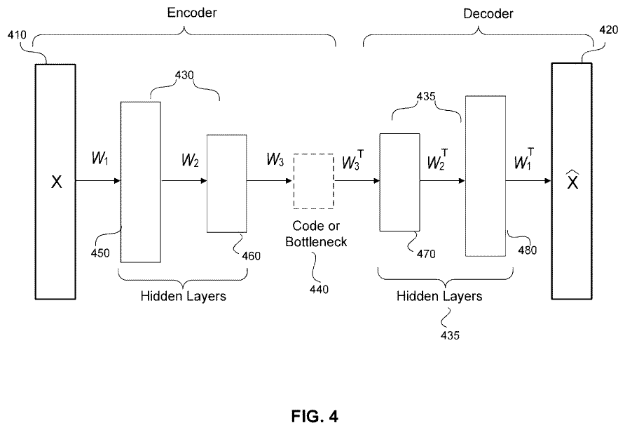

FIG. 4 is a schematic diagram illustrating an example of a sandwich structure of an autoencoder, in which the structures of the encoder and decoder are symmetric. In the sandwich structure, the input layer 410 and the output layer 420 are positioned on the outermost layers, while the hidden layers 430 are sandwiched in between. In the outermost structure of the autoencoder illustrated in FIG. 4, the structures of the encoder and the decoder are symmetric in several aspects. First, the numbers of layers in the encoder and in the decoder may be the same, with the exception that there may be one additional layer known as the code or bottleneck layer 440 in the encoder. Second, the number of neural nodes in the input layer 410 of the encoder may be the same as the number of neural nodes in the output layer 420 of the decoder. Third, the number of encoder hidden layers 430 and decoder hidden layers 435 (i.e., a layer may be a hidden layer if the layer may not be an input layer 410, an output layer 420 or a code/bottleneck layer 440) in the encoder and in the decoder may be the same. Fourth, the vector of weights/parameters between the input layer 410 and the first hidden layer 450 in the encoder may be the transpose of the vector of weights/parameters between the output layer 420 and the first hidden layer 480 in the decoder. The vector of weights/parameters between the first hidden layer 450 and the second hidden layer 460 in the encoder may be the transpose of the vector of weights/parameters between the first hidden layer 480 and the second hidden layer 470 in the decoder, and so on. As shown in FIG. 4, W₁^{T} is the transpose of W₁, W₂^{T} is the transpose of W₂, and so on.

For the sandwich structure shown in FIG. 4, the encoder and decoder of the autoencoder may synchronize their structures and weights/parameters. There may be a tradeoff between the complication of the structure and the performance of the reconstruction in the design of an autoencoder. A sandwich structure may be designed to significantly reduce the dimension of the encoder input and fully reconstruct the compressed representation at the output of the decoder. However, an over fitting issue may occur (i.e., the differences/errors between the input and output of the autoencoder may increase when the input of the autoencoder changes). On the contrary, the structure may be designed with a simpler structure creating larger differences/errors between the input and output of the autoencoder.

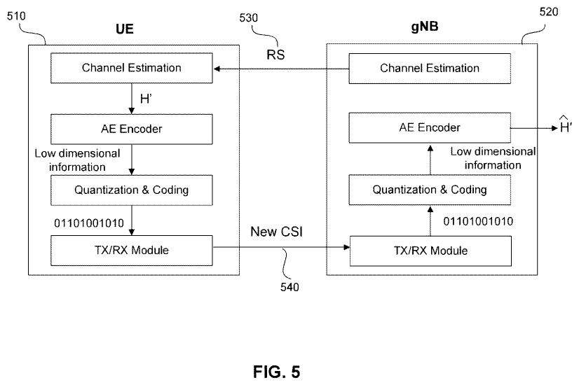

The following describes the use of an autoencoder to implement CSI compression. A general architecture of applying an autoencoder to CSI compression for 3GPP NR is illustrated in FIG. 5. First, base station 520 (denoted as gNB) sends reference signal RS 530 (on PDSCH/PDCCH) to UE 510. Upon receiving reference signal RS 530, UE 510 estimates the channel condition (denoted as H′). The encoder of the autoencoder (denoted as the AE encoder) may be located at UE 510 and the decoder of an autoencoder (denoted as the AE decoder) may be located at base station 520. After the estimation of H′ at UE 510, the AE encoder may compress H′ to low dimensional information. Then, a quantization and coding process may be conducted to transfer low dimensional information to a bit stream with a certain number of bits, and the bit stream may represent a new, low dimension version of the CSI 540. The transceiver (TX/RX) module at the UE 510 may send the low dimension version of CSI to the base station 520. After receiving the low dimension version of CS 540 via the TX/RX module in base station 520, a decoding and dequantization process in base station 520 may proceed to transfer the bit stream to low dimensional information. Finally, the AE decoder in base station 520 may reconstruct low dimensional information to the channel condition (denoted as H′). In FIG. 5, the AE encoder and quantization & coding in UE 510 may implement the CSI bit stream generation and the AE decoder and decoding & dequantization in base station 520 may implement the decoding of the CSI to reconstruct the high dimension version of the CSI to determine the channel condition.

Under this general architecture, there may be two critical challenges. First, in traditional applications in which an autoencoder is used (e.g., video/audio processing, principle characteristic analytics, etc.), the autoencoder, including both the AE encoder and AE decoder, may be installed on the same machine. In the case of CSI compression, the architecture may have information on both the input and output of the autoencoder, due to both being resident within the apparatus in the architecture (e.g., on UE 510 and on base station 520), and therefore this architecture may dictate measurement of the differences/errors between the input and output of the autoencoder. As a result, the architecture may involve updating the weights/parameters of both the AE encoder and AE decoder based on the measured differences/errors. However, when the autoencoder may be applied to CSI feedback compression, UE 510 (AE encoder) may have information related to the channel condition directly, and base station 520 (AE decoder) may have information related to the channel condition only based on the result of the channel reconstruction. Consequently, UE 510 and base station 520 may not have complete information on the differences/errors between the input and the output of the autoencoder, and thus, due to incomplete information regarding the channel condition, UE 510 and base station 520 may not be able to update the weights/parameters of the AE encoder and AE decoder.

Second, the weights/parameters of AE encoder and AE decoder may periodically be updated but the differences/errors may not significantly decrease. In such a circumstance, the current structures of AE encoder and AE decoder may not be adequate. In this case, the structures of AE encoder and AE decoder may be changed. The derivation of adequate structures of AE encoder and AE decoder may be based on the differences/errors between the input and the output of the autoencoder. If UE 510 and base station 520 may not have information on the differences/errors between the input and the output of the autoencoder, then both UE 510 and base station 520 may not be able to determine improved weights/parameters and structures for the AE encoder and AE decoder.

To address, at least in part, these two challenges in applying the autoencoder to CSI compression in 3GPP NR, the disclosed embodiments provide methods and apparatus which may comprise of two stages: an initial stage and a second stage. The purpose of the initial stage may be two parts. First, both the UE and the base station may have a common understanding of the supported structures of the AE encoder and AE decoder. Second, both the UE and the base station may have a common understanding of the adopted CSI bit-stream generation and decoding scheme. For the second stage, once the AE encoder of the UE and the AE decoder of the base station structures are adopted by the UE and base station, at least some disclosed embodiments implement CSI compression and update weights/parameters and structures accordingly.

For the initial stage, one or more aspects of the present application may be applicable. A certain number of autoencoder encoder/decoder structures for CSI feedback may be provided. The base station may communicate the supported autoencoder encoder/decoder structures (all or a part of structures) to the UE. This information may be conveyed by, for example, MasterInformationBlock (MIB) or SystemInformationBlock (SIB) in NR. The UE may communicate the supported autoencoder encoder/decoder structures (all or a part of structures in standards) to the base station. This information may be conveyed by, for example, UE Capability Information of the radio resource control (RRC) signaling in NR.

In some embodiments, the adopted autoencoder encoder/decoder structure may be determined by the network (base station or Core Network, CN) and the network may inform this configuration to the UE. In other embodiments, the adopted autoencoder encoder/decoder structure may be determined by the UE and the UE may inform this configuration to the network. In this case, the network may allocate radio resources for the UE to send this configuration. In other embodiments, the adopted autoencoder encoder/decoder structure may be specified in the standards.

In some embodiments, the adopted weights/parameters of both the AE encoder and AE decoder may be determined by the network and the network may communicate this configuration to the UE. In other embodiments, the adopted weights/parameters of both the AE encoder and AE decoder may be determined by the UE and the UE may communicate this configuration to the network. In this case, the network may allocate radio resources for the UE to send this configuration. In other embodiments, the adopted weights/parameters of both the AE encoder and AE decoder may be specified in the standards.

A certain number of CSI bit-stream generation/decoding schemes may be provided. A base station may communicate the supported CSI bit-stream generation/decoding schemes (all or a part of schemes) to the UE. This information may be conveyed by, for example, MasterInformationBlock (MIB) or SystemInformationBlock (SIB) in NR. The UE may communicate the supported CSI bit-stream generation/decoding schemes (all or a part of schemes) to the base station. This information may be conveyed by, for example, UE Capability Information of the RRC signaling in NR.

In some embodiments, the adopted CSI bit-stream generation/decoding scheme may be determined by the network and the network may communicate this configuration to the UE. In other embodiments, the adopted CSI bit-stream generation/decoding scheme may be determined by the UE and the UE may communicate this configuration to the network. In this case, the network may allocate radio resources for the UE to send the configuration. In other embodiments, the adopted CSI bit-stream generation/decoding scheme may be specified.

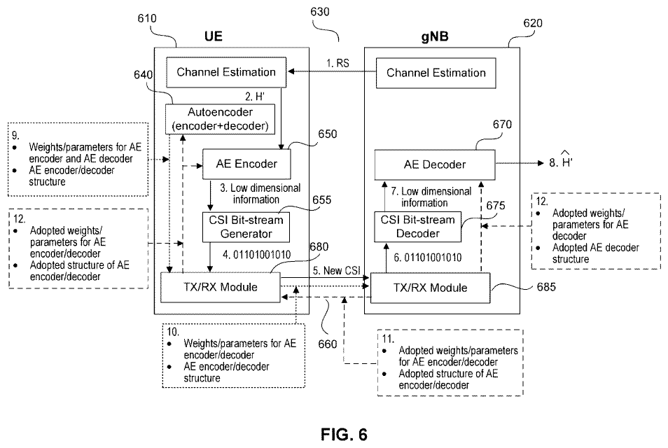

Consistent with some disclosed embodiments, in alternatives for the design of the second stage, after the initial stage, both the UE and the base station may have information associated with the adopted structures of AE encoder and AE decoder, the weights/parameters for the AE encoder and AE decoder, and the CSI bit-stream generation and decoding schemes. In the design of the second stage, methods and apparatus described and exemplified herein may provide two alternatives. In FIG. 6 a block diagram of an example of the implementation of a first alternative to the second stage is illustrated where the UE may provide updated weights/parameters to the base station in the implementation for CSI compression. The first alternative to the second stage may involve several steps. First, a base station 620 (i.e., gNB) may send reference signal RS 630 in one or more downlink transmissions. After receiving reference signal RS 630, UE 610 may estimate the channel condition H'. The AE encoder 650 in UE 610 then may reduce the dimension of the estimated channel condition to generate low dimensional information.

The CSI bit-stream generator 655 in UE 610 may transfer low dimensional information to a CSI bit stream generator with a certain number of bits. A TX/RX module 680 of UE 610 may then transmit the bit stream as a low dimension version of the CSI 660 to base station 620. Upon receiving the bit stream including the low dimension version of the CSI 660, a TX/RX module 685 in base station 620 may provide the bit stream as input to a CSI bit-stream decoder 675. The CSI bit-stream decoder 675 in base station 620 may convert the bit stream to low dimensional information. The AE decoder 670 at base station 620 may then reconstruct the channel condition. The autoencoder 640 in UE 610 may measure the differences/errors of its own input and output based on a certain loss function. Based on the differences/errors, autoencoder 640 in UE 610 may update the weights/parameters for both the AE encoder 650 in UE 610 and the AE decoder 670 in base station 620. In addition, autoencoder 640 in UE 610 may select other structures for both AE encoder 650 in UE 610 and AE decoder 670 in base station 620. Thus, the TX/RX module in UE 610 may send one or more of the updated weights/parameters for AE encoder 650 in UE 610 and/or AE decoder 670 in base station 620 and/or structures of AE encoder 650 in UE 610 and AE decoder 670 in base station 620 to base station 620.

After receiving one or more of the updated weights/parameters for AE encoder 650 in UE 610 and/or AE decoder 670 in base station 620 and/or structures of AE encoder 650 in UE 610 and AE decoder 670 in base station 620, base station 620 may further confirm or determine one or more of the adopted weights/parameters for AE encoder 650 in UE 610 and/or AE decoder 670 in base station 620 and/or the adopted structures of AE encoder 650 in UE 610 and AE decoder 670 in base station 620. Base station 620 may then communicate the adopted weights/parameters for AE encoder 650 to UE 610 and update AE decoder 670 in base station 620 and/or may communicate the adopted structures of AE encoder 650 to UE 610 and update AE decoder 670 in base station 620. AE decoder 670 in base station 620 may then use the adopted weights/parameters or the structure determined by base station 620. AE encoder 650 in UE 610 and autoencoder 640 in UE 610 may also use the updated weights/parameters or the structure decided by base station 620.

Consistent with disclosed embodiments aspects of the present application, the UE may include an autoencoder (including an encoder and a decoder), an AE encoder, and a CSI bit-stream generator. The base station may include an AE decoder and a CSI bit-stream decoder. After an initial stage, the UE may update the weights/parameters of the AE encoder in the UE and the AE decoder in the base station (using the autoencoder in the UE), and the UE may communicate the updated weights/parameters to the base station. A base station may allocate radio resources for the UE to upload the updated weights/parameters. After receiving the updated weights/parameters from the UE, the base station may further communicate or confirm to the UE the information including the adopted weights/parameters.

In the UE, when the adopted weights/parameters provided by the base station may be received by the UE, the AE encoder may use the adopted weights/parameters provided by the base station to implement CSI compression. The CSI bit-stream generator may then convert the compressed CSI to a bit stream with a certain number of bits. The autoencoder may use the adopted weights/parameters provided by the base station to further update weights/parameters. In the base station, the CSI bit-stream decoder may convert the bit stream received from the UE to obtain the compressed CSI. The AE decoder may use the adopted weights/parameters to reconstruct the CSI to determine the channel condition.

After the initial stage, the UE may select a different AE encoder/decoder structure from the set of AE encoder/decoder structures that may be supported by the UE and base station. The UE may communicate to the base station the selected AE encoder/decoder structures. The base station may allocate radio resources for the UE to communicate to the base station the selected AE encoder/decoder structures. The base station may further communicate to the UE the adopted AE encoder/decoder structures. The AE decoder in the base station may then use the adopted structure.

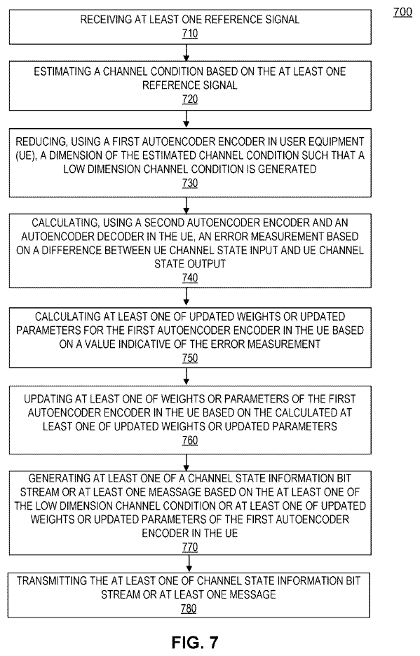

FIG. 7 is a flow chart illustrating a method 700 for managing channel state information feedback compression in UE, consistent with disclosed embodiments described and exemplified herein. The method 700 may involve an initial stage (not shown in FIG. 7), wherein both the UE and a base station may be configured with information associated with adopted structures of an AE encoder and an AE decoder, the weights/parameters for the AE encoder and AE decoder, and the CSI bit-stream generation and decoding schemes.

Referring to FIG. 7, method 700 includes a step 710 of the UE receiving at least one reference signal from the base station. In embodiments, the UE may receive at least one reference signal that may be used for various purposes, including, but not limited to, synchronization, channel estimation, and signal quality measurement. The reference signal(s) may be transmitted by the base station and received by the UE to facilitate reliable communication between the two (i.e., the at least one reference signal may be received by the UE from the base station). Consistent with disclosed embodiments, the at least one reference signal may be used by the UE to determine the channel condition of the Uu link between the UE and the base station.

The method 700 includes a step 720 of the UE estimating the channel condition based on the at least one reference signal. Estimating the channel condition may refer to the UE analyzing the quality and characteristics of the wireless channel between itself and the base station including determining the signal strength, interference levels, and other factors that can affect the communication performance. The UE may estimate the channel condition by analyzing the at least one reference signal received from the base station.

The method 700 includes a step 730 of the UE reducing, using a first autoencoder encoder in the UE, a dimension of the estimated channel condition such that a low dimension channel condition is generated. Reducing the dimension of the estimated channel condition may refer to using the autoencoder encoder to compress high-dimensional data into a lower-dimensional representation. In some disclosed embodiments, the autoencoder encoder in the UE may be based on a deep neural network. The deep neural network may include a plurality of neural nodes and each of the neural nodes may include weights and parameters used to generate an output based on the neural node input. This reduction may provide a reduction in the number of bits for transmitting the estimated channel condition from the UE to the base station. It is to be appreciated that the lower dimension representation of the estimated channel condition that may be received by the base station via the CSI may be reconstructed to the higher-dimensional representation using a corresponding autoencoder decoder in the base station.

The method 700 includes a step 740 of the UE calculating, using a second autoencoder encoder and an autoencoder decoder in the UE, an error measurement based on a difference between UE channel state input and UE channel state output. For example, the autoencoder in the UE may measure the differences or errors by comparison of its input and its output using a loss function. Thus, the calculating of the error measurement may be based on a difference between UE channel state input and UE channel state output and may include using a loss function to perform the calculation.

The method 700 includes a step 750 of the UE calculating at least one of updated weights or updated parameters for the autoencoder encoder in the UE based on a value indicative of the error measurement. In light of the channel condition and the error expected, corresponding to the value indicative of the error measurement, between the autoencoder encoder of the UE and the autoencoder decoder of the base station, the UE may generate updated weights or updated parameters for its autoencoder encoder to account for the value indicative of the error measurement. The autoencoder decoder in the base station may be provided with corresponding updated weights/parameters and structures consistent with the updated weights/parameters and structures of the autoencoder encoder in the UE.

The method 700 includes a step 760 of the UE updating at least one of weights or parameters of the first autoencoder encoder in the UE based on the calculated at least one of updated weights or updated parameters. Based on the calculated at least one of updated weights or updated parameters, the UE may update its first autoencoder encoder to match the autoencoder decoder in the base station.

The method 700 includes a step 770 of the UE generating at least one of a CSI bit stream or at least one message based on the at least one of the low dimension channel condition or at least one of updated weights or updated parameters of the first autoencoder encoder in the UE. The CSI bit stream may refer to the stream of bits that contains information about the current state of the wireless channel between the base station and the UE. The at least one message may refer to at least one packet, PDU or other unit of data that may be sent and/or received in data communication. In disclosed embodiments, the at least one message may be present in data communication from the UE to the base station (and/or from the base station to the UE). Based on the updated weights and/or updated parameters calculated and updated based on the value indicative of the error measurement, the UE may generate either a channel state bit stream or at least one message that may include at least one of the low dimension channel condition, at least one of updated weights or updated parameters of the first autoencoder encoder in the UE or the at least one of update weights or updated parameters of the autoencoder decoder in the base station.

The method 700 includes a step 780 of the UE transmitting the at least one of the CSI bit stream or the at least one message. Once the CSI may be generated, it may be transmitted to the base station via the CSI bit stream. In disclosed embodiments, the stream of bits that contains information about the current state of the wireless channel between the base station and the UE may also include information about the autoencoder components in the base station and the UE (e.g., weights, parameters and structure information for the autoencoder components to implement CSI compression). Alternatively (or additionally), information about the autoencoder components in the base station and the UE may be conveyed in messages other than the CSI bit stream (e.g., the at least one message). For example, one or more messages may be sent from the UE communicating the information about the autoencoder components in the base station and the UE in a separate data communication.

In some embodiments, the method 700 may further comprise the UE calculating at least one of updated weights or updated parameters for an autoencoder decoder in a base station based on the value indicative of the error measurement; and transmitting, to the base station, the at least one of updated weights or updated parameters for the autoencoder decoder in the base station. Thus, the UE may communicate to the base station the updated weights and/or parameters corresponding to the autoencoder decoder in the base station.

In some embodiments, the method 700 may further comprise the UE receiving one or more of autoencoder encoder weights, autoencoder encoder parameters, autoencoder encoder structure, autoencoder decoder weights, autoencoder decoder parameters, or autoencoder decoder structure. For example, the UE may receive autoencoder encoder structure and/or autoencoder decoder structure, e.g., included in a master information block message and/or a system information block message.

In some embodiments, the method 700 may involve the UE being configured with information associated with autoencoder encoder adopted structure, autoencoder decoder adopted structure, autoencoder encoder weights, autoencoder decoder weights, autoencoder encoder structure, autoencoder decoder structure, channel state information bit stream generation, and decoding schemes.

In some embodiments, the method 700 may further comprise the UE transmitting information relating to at least one of the first autoencoder encoder in the UE, the second autoencoder encoder in the UE, the autoencoder decoder in the UE, an autoencoder decoder in a base station, or calculated weights or parameters of at least one of the first autoencoder encoder in the UE, the second autoencoder encoder in the UE, the autoencoder decoder in the UE, or the autoencoder decoder in the base station. For example, the UE may include an algorithm that may allow for the calculation of the weights/parameters and the determination of the appropriate structure in the autoencoder components to implement CSI compression and the UE may transmit that information to the base station.

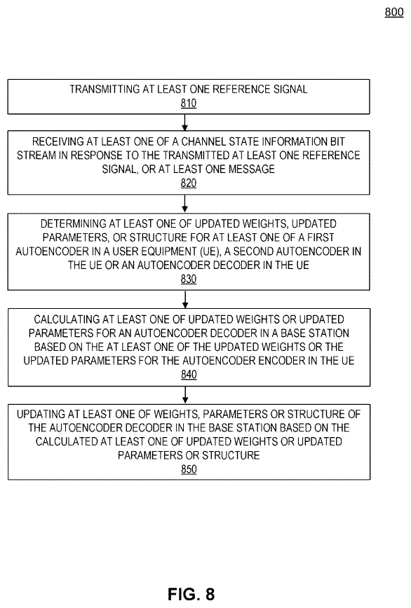

FIG. 8 is a flow chart illustrating a method 800 for managing channel state information feedback compression in a gNB, consistent with disclosed embodiments described and exemplified herein. The method 800 may involve an initial stage (not shown in FIG. 8), wherein both the base station and a UE may be configured with information associated with adopted structures of an AE encoder and an AE decoder, the weights/parameters for the AE encoder and AE decoder, and the CSI bit-stream generation and decoding schemes.

Referring to FIG. 8, method 800 includes a step 810 of the base station transmitting at least one reference signal. In embodiments, the base station may transmit the reference signal to the UE to allow the UE to estimate the channel condition. The reference signal may provide information about the channel quality, such as signal strength and interference levels. The UE may use the received reference signal to optimize its transmission and reception on the wireless channel.

The method 800 includes a step 820 of the base station receiving a CSI bit stream or at least one message in response to the transmitted at least one reference signal. In disclosed embodiments, the base station may receive a stream of bits that provide information about the current state of the channel between the base station and the UE based, at least in part, on the estimated channel condition as determined by the UE. Thus, the at least one reference signal may be transmitted to the UE, and the channel state information bit stream may be received from the UE.

The method 800 includes a step 830 of the base station determining at least one of updated weights, updated parameters, or structure for at least one of a first autoencoder in the UE, a second autoencoder in the UE or an autoencoder decoder in the UE based on at least one of the CSI bit stream or one or more messages conveying this information. In some disclosed embodiments, the base station may extract information related to updated weights, updated parameters or updated structure of the autoencoder components in the UE and in the base station from at least one of the CSI bit stream or from one or more messages separate from the CSI bit stream conveying this information.

The method 800 includes a step 840 of the base station calculating at least one of updated weights or updated parameters for an autoencoder decoder in a base station based on the at least one of the updated weights or the updated parameters for the autoencoder encoder in the UE. In some disclosed embodiments, the base station may receive the updated weights and/or updated parameters for the autoencoder encoder in the UE and calculate updated weights and/or update parameters for the autoencoder decoder in the base station to correspond to the autoencoder encoder in the UE. The base station may determine associated updated weights, parameters and/or structures of autoencoder components used for implementing CSI compression and may calculate corresponding updated weights, parameters and/or structure for the autoencoder decoder in the base station.

The method 800 includes a step 850 of the base station updating at least one of weights, parameters or structure of the autoencoder decoder in the base station based on the calculated at least one of updated weights or updated parameters. Once the weights, parameters or structure for the autoencoder decoder have been calculated, the base station may update the weights, parameters and/or structure of the autoencoder decoder in the base station accordingly.

The method 800 may further comprise receiving, from the UE, at least one of calculated weights, parameters or updated structure for at least one of the autoencoder decoder in the base station, the first autoencoder encoder in the UE, the second autoencoder encoder in the UE, or the autoencoder decoder in the UE. In some embodiments, the updated structure may be a sandwich structure. In some embodiments, the base station may receive from the UE updated weights, parameters and/or structure for one or more autoencoder components in the UE and in the base station.

The method 800 may further comprise transmitting, to the UE, at least one of the calculated weights, parameters or structure for at least one of the autoencoder decoder in the base station, the first autoencoder encoder in the UE, the second autoencoder encoder in the UE, or the autoencoder decoder in the UE. The base station may transmit weights, parameters and/or structure back to the UE to allow updates or to confirm updates of autoencoder components throughout the system to make sure the weights, parameters and/or structures in the UE and in the base station correspond.

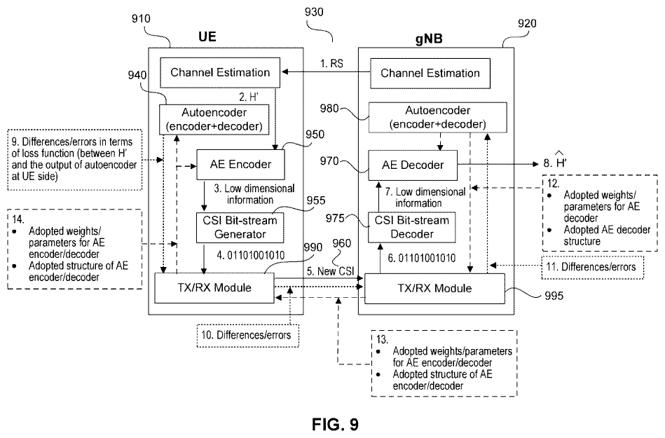

Consistent with some disclosed embodiments, both the UE and base station may have information associated with the adopted structures of the AE encoder and the AE decoder, the weights/parameters for the AE encoder and the AE decoder, and the CSI bit-stream generation and decoding schemes. FIG. 9 is a schematic diagram illustrating an example of the implementation of such an arrangement. The schematic diagram of FIG. 9 has some similarities to the schematic diagram of FIG. 6, and some notable differences will be apparent in the following discussion of FIG. 9.

First, base station 920 (i.e., gNB) may send reference signal RS 930 in one or more downlink transmissions. After receiving reference signal RS 930, UE 910 may estimate the channel condition. The AE encoder 950 in UE 910 then may reduce the dimension of the estimated channel condition to generate low dimensional information H′.

The AE encoder 950 in UE 910 may transfer low dimensional information H′ to a CSI bit stream generator 955 with a certain number of bits. The TX/RX module 990 in UE 910 may then transmit the bit stream as a low dimension version of the CSI 960 to base station 920. Upon receiving the bit stream including the low dimension version of the CSI 960, the TX/RX module 995 in base station 920 may input the bit stream to a CSI bit-stream decoder 975. The CSI bit-stream decoder 975 in base station 920 may convert the bit stream to low dimensional information. The AE decoder 970 at base station 920 may then reconstruct the channel condition. The autoencoder 940 in UE 910 may measure the differences and/or errors of its own input and output based on a certain loss function. Based on the differences/errors, UE 910 may transmit a message regarding such differences/errors to the base station 920. The UE 910 may transmit such a message periodically, or this message may be transmitted when the differences and/or errors may be larger than a certain threshold. The event to transmit the message may be decided by base station 920, and base station 920 may communicate with the UE 910 the configuration for the event.

When base station 920 receives the message from UE 910 communicating the differences/errors, the autoencoder 980 in base station 920 may update the weights/parameters for AE encoder 950 in the UE 910 and AE decoder 970 in base station 920 or may select another structure for AE encoder 950 in UE 910 and AE decoder 970 in base station 920. The AE decoder 970 in base station 920 may use the updated weights/parameters or the updated structure. Base station 920 may communicate to UE 910 the updated weights/parameters for the AE encoder 950 in the UE 910 and/or AE decoder 970 in the base station, or the adopted structures for AE encoder 950 in UE 910 and/or AE decoder 970 in base station 920. The autoencoder 940 and AE encoder 950 in UE 910 may use the updated weights/parameters or the updated structure.

Consistent with disclosed embodiments, the base station may include an autoencoder (including an encoder and a decoder), an AE decoder, and a CSI bit-stream decoder. The UE may have an autoencoder (including an encoder and a decoder), an AE encoder, and a CSI bit-stream generator. After an initial stage, the base station may update the weights/parameters of the AE encoder in the UE and AE decoder in the base station based on a message sent by the UE about the feasibility of the updated weights/parameters, and the base station may communicate to the UE the updated weights/parameters. The base station may allocate radio resources to transmit the updated weights/parameters (e.g., conveyed by control channel or shared channel). The UE may send a message to communicate to the base station about the feasibility of the currently adopted weights/parameters (e.g., differences/errors between the estimated channel condition and the output of the autoencoder in the UE). Such differences/errors may be derived based on a particular loss function. The message about the feasibility of the currently adopted weights/parameters may be sent periodically or may be sent when the differences/errors are larger than a certain threshold. The events to send the message may be determined by the base station and the base station may communicate to the UE such configuration (for the events). The base station may allocate radio resources for the UE to send the message.

In the UE, the autoencoder may use the adopted weights/parameters provided by the base station to compress the channel and reconstruct the channel. The autoencoder may derive the errors/differences between the channel condition and the reconstructed channel condition to measure the feasibility of the adopted weights/parameters communicated by the base station. The AE encoder in the UE may use the adopted weights/parameters provided by the base station to compress CSI. The CSI bit-stream generator may then convert the compressed CSI to a bit stream with a certain number of bits. In the base station, the autoencoder may update the weights/parameters for the autoencoder and AE encoder in the UE, and the AE decoder in the base station. The CSI bit-stream decoder may convert the bit stream received from the UE to obtain the compressed CSI. The AE decoder may use the updated weights/parameters to reconstruct the CSI.

After an initial stage, the base station may select other structures of the autoencoder and the AE encoder/decoder from a set of autoencoder and AE encoder/decoder structures commonly supported by the UE and by the base station (based on the message about the feasibility of the currently adopted weights/parameters sent by the UE), and the base station may communicate to the UE the selected structures. The base station may allocate radio resources to communicate to the UE the selected structures (e.g., conveyed by the control channel or shared channel). The UE may send a message to the base station to communicate the feasibility of the currently adopted structures (e.g., differences/errors between the estimated channel condition and output of autoencoder in the UE). Such differences/errors may be derived based on a particular loss function. Such a message (about the feasibility of the currently adopted structure) may be sent periodically or may be sent when the differences/errors are larger than a certain threshold. The events to send the message may be determined by the base station and the base station may communicate to the UE the configuration (for the events). The base station may allocate radio resources for the UE to send the message. The AE decoder in the base station may then use the adopted structure. The autoencoder and AE encoder in the UE may then use the adopted structure.

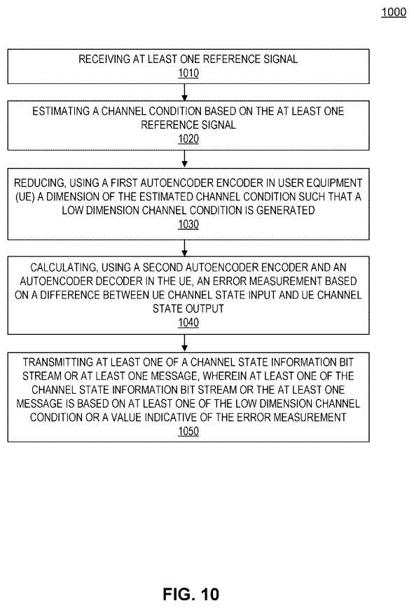

FIG. 10 is a flow chart illustrating a method 1000 for managing channel state information feedback compression in UE, consistent with disclosed embodiments described and exemplified herein. The method 1000 may involve an initial stage (not shown in FIG. 10), wherein both the UE and a base station may be configured with information associated with adopted structures of an AE encoder and an AE decoder, the weights/parameters for the AE encoder and AE decoder, and the CSI bit-stream generation and decoding schemes.

Referring to FIG. 10, method 1000 includes a step 1010 of the UE receiving at least one reference signal from the base station. In embodiments, the UE may receive at least one reference signal that may be used for various purposes, including but not limited to synchronization, channel estimation, and signal quality measurement. These reference signals may be transmitted by the base station and received by the UE to facilitate reliable communication between the two (i.e., the at least one reference signal may be received from the base station). Consistent with disclosed embodiments, the reference signal may be used by the UE to determine the channel condition of the Uu link between the UE and the base station.

The method 1000 includes a step 1020 of the UE estimating the channel condition based on the at least one reference signal. Estimating the channel condition may refer to the UE analyzing the quality and characteristics of the wireless channel between itself and the base station including determining the signal strength, interference levels, and other factors that can affect the communication performance. The UE may estimate the channel condition by analyzing the at least one reference signal received from the base station.

The method 1000 includes a step 1030 of the UE reducing, using a first autoencoder encoder (i.e., AE encoder) in the UE, a dimension of the estimated channel condition such that a low dimension channel condition is generated. As described previously in this disclosure, the autoencoder may be used for dimensionality reduction. In some disclosed embodiments, the input to the first autoencoder encoder of the estimated channel condition may be a high dimension channel condition. In disclosed embodiments, the first autoencoder encoder in the UE may be used to convert the high dimension estimated channel condition into a low dimension estimated channel condition. In some disclosed embodiments, the first autoencoder encoder may be based on a deep neural network. The deep neural network may include a plurality of neural nodes and each of the neural nodes may include weights and parameters used to generate an output based on the neural node input. This reduction may involve a reduction in the number of bits for transmitting the estimated channel condition from the UE to the base station.

The method 1000 includes a step 1040 of the UE calculating, using a second autoencoder encoder and an autoencoder decoder, which form an autoencoder in the UE, an error measurement based on a difference between UE channel state input and UE channel state output. For example, the autoencoder in the UE may measure the differences or errors in comparison of its input and its output based on a loss function. Thus, the calculating of the error measurement may be based on a difference between UE channel state input and UE channel state output and may include using a loss function to perform the calculation. Based on the determined differences or errors from the calculated error measurement by the autoencoder, the UE may update the weights/parameters and/or structures for both the AE encoder at the UE and the AE decoder in the base station. The training of the autoencoder in the UE may configure the autoencoder to determine the difference or errors between its input and its output.

The method 1000 includes a step 1050 of the UE transmitting the at least one of a CSI bit stream or at least one message, wherein the at least one of CSI bit stream or at least one message is based on at least one of the low dimension channel condition or a value indicative of the error measurement. The CSI bit stream may be transmitted to the base station. The transmitted CSI bit stream that may be received by the base station and may be decoded by the CSI bit stream decoder in the base station to recover the original, high dimension estimated channel condition. Alternatively (or additionally), one or more messages may be transmitted to the base station separate from the CSI bit stream. The CSI bit stream or the one or more messages transmitted to the base station may contain at least one of the low dimension channel condition or the value indicative of the error measurement.

The method 1000 may further comprise the UE generating at least one of the CSI bit stream or at least one message based on at least one of the low dimension channel condition or the value indicative of the error measurement. In disclosed embodiments, the base station may use either the low dimension channel condition, the differences or errors as measured by the autoencoder in the UE or both to determine changes to the weights/parameters that may be used by the base station autoencoder decoder (i.e., AE decoder) to match the autoencoder encoder (i.e., AE encoder) in the UE.

In an initial stage, the method 1000 may further include the UE receiving an autoencoder encoder structure and the base station receiving the autoencoder decoder structure. In some disclosed embodiments, the autoencoder encoder and autoencoder decoder structures may be included in at least one of a MIB message or a SIB message. Thus, the structures of the autoencoder encoder and autoencoder in the UE and the autoencoder decoder in the base station may be distributed in the initial stage configuring the architecture to operate consistent with disclosed embodiments.

In some embodiments, the method 1000 may further comprise the UE receiving one or more of autoencoder encoder weights, autoencoder encoder parameters, autoencoder encoder structure, autoencoder decoder weights, autoencoder decoder parameters, or autoencoder decoder structure. For example, the UE may receive autoencoder encoder structure and/or autoencoder decoder structure, e.g., included in a master information block message and/or a system information block message.

In some embodiments, the method 1000 may involve the UE being configured with information associated with autoencoder encoder adopted structure, autoencoder decoder adopted structure, autoencoder encoder weights, autoencoder decoder weights, autoencoder encoder structure, autoencoder decoder structure, channel state information bit stream generation, and decoding schemes.

In some embodiments, the method 1000 may further comprise the UE transmitting information relating to at least one of the first autoencoder encoder in the UE, the second autoencoder encoder in the UE, the autoencoder decoder in the UE, an autoencoder decoder in a base station, or calculated weights or parameters of at least one of the first autoencoder encoder in the UE, the second autoencoder encoder in the UE, the autoencoder decoder in the UE, or the autoencoder decoder in the base station. For example, the UE may include an algorithm that may allow for the calculation of the weights/parameters and the determination of the appropriate structure in the autoencoder components to implement CSI compression and the UE may transmit that information to the base station.

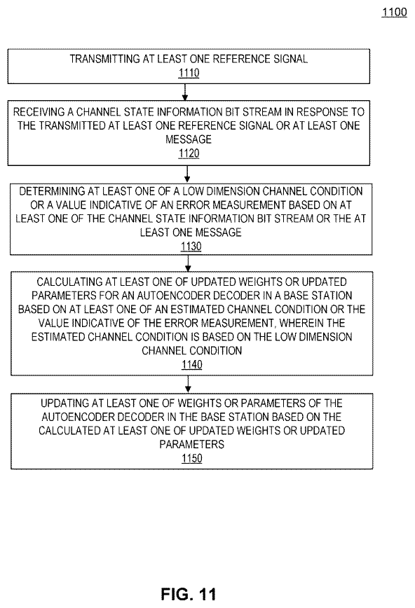

FIG. 11 is a flow chart illustrating a method 1100 for managing CSI feedback compression in a gNB, consistent with disclosed embodiments described and exemplified herein. The method 1100 may involve an initial stage (not shown in FIG. 11), wherein both the base station and a UE may be configured with information associated with adopted structures of an AE encoder and an AE decoder, the weights/parameters for the AE encoder and AE decoder, and the CSI bit-stream generation and decoding schemes.

Referring to FIG. 11, method 1100 includes a step 1110 of the base station transmitting at least one reference signal. In embodiments, the base station may transmit the reference signal to the UE to allow the UE to estimate the channel condition. The reference signal may provide information about the channel quality, such as signal strength and interference levels. The UE may use the received reference signal to optimize its transmission and reception.

The method 1100 includes a step 1120 of the base station receiving at least one of the CSI bit streams in response to the transmitted at least one reference signal or at least one message. In disclosed embodiments, the base station may receive a stream of bits that provide information about the current state of the channel between the base station and the UE based, at least in part, on the estimated channel condition as determined by the UE. Thus, the at least one reference signal may be transmitted to the UE, and the CSI bit stream may be received from UE. Alternatively, the base station may receive at least one message from the UE including information described in disclosed embodiments.

The method 1100 includes a step 1130 of the base station determining at least one of a low dimension channel condition or a value indicative of an error measurement based on the CSI bit stream or the at least one message. As described and exemplified herein, the base station may use a CSI bit stream decoder to extract the low dimension channel condition and/or the value indicative of the error measurement received from the UE from the CSI bit stream. Alternatively, the base station may also receive a value indicative of an error measurement from one or more messages separately from the CSI bit stream. The base station may input the recovered low dimension channel condition information into an autoencoder decoder (i.e., AE decoder) to recover the original high dimension channel condition determined by the UE. Thus, the estimated channel condition may be determined using the autoencoder decoder in the base station to decode the low dimension channel condition and recover the original estimated channel condition. In some disclosed embodiments, the autoencoder decoder in the base station may be based on a deep neural network. The deep neural network implementing the autoencoder decoder may include a plurality of neural nodes and each of the neural nodes may include weights and parameters used to generate an output based on the neural node input. In some embodiments, the low dimension channel condition may be converted to a high dimension channel condition using the autoencoder decoder in the base station.

The method 1100 includes a step 1140 of the base station calculating at least one of updated weights or updated parameters for the autoencoder decoder in a base station based on at least one of an estimated channel condition or the value indicative of the error measurement, wherein the estimated channel condition may be based on the low dimension channel condition. In disclosed embodiments, the UE may provide information about the channel condition via the CSI bit stream such that differences caused by changes in the channel condition may be compensated to correct for inaccuracy in the CSI compression by updating the weight/parameters and/or structures in the autoencoder components in the UE and in the base station. Thus, calculating at least one of updated weights or updated parameters for the autoencoder decoder in the base station may include calculating at least one of updated weights or updated parameters for the autoencoder decoder in the base station based on the value indicative of the error measurement. For example, the error measurement may be used to determine changes that may be needed to the weights or parameters of the autoencoder decoder to match the autoencoder encoder in the UE. Thus, the error measurement may be used in an algorithm implemented in the base station to generate updated weights and/or updated parameters for the autoencoder decoder in the base station. At least one of updated weights or updated parameters for the autoencoder decoder in the base station may correspond to at least one of updated weights or updated parameters for an autoencoder encoder in the UE. At least one of autoencoder encoder structure or autoencoder decoder structure may be transmitted to the UE.

The method 1100 includes a step 1150 of the base station updating at least one of weights or parameters of the autoencoder decoder in the base station based on the calculated at least one of updated weights or updated parameters. Step 1150 implements the update of the autoencoder decoder in the base station to correspond to the update of the autoencoder encoder in the UE and to compensate for changes in the channel condition that may have caused the differences or errors in CSI compression between the UE and the base station.

In some disclosed embodiments, calculating at least one of updated weights or updated parameters may further include calculating at least one of updated weights or updated parameters for each of a first autoencoder encoder (i.e., AE encoder) in the UE, a second autoencoder encoder in the UE, and an autoencoder decoder in the UE, wherein the second autoencoder encoder and the autoencoder decoder in the UE belong to the same autoencoder pair. For example, the autoencoder components in the UE and in the base station may need weights and parameters that are calculated to provide identical (or nearly identical) outputs for a particular input. Thus, each autoencoder component in the UE and in the base station may need updated weights, updated parameters and/or updated structures to maintain outputs that match. Further, calculating at least one of updated weights or updated parameters may include updating at least one of weights or parameters for the first autoencoder encoder in the UE, for the second autoencoder encoder in the UE, and for the autoencoder decoder in the UE. Once the weights and/or parameters are calculated then the weights and parameters may be used to update the weights and parameters in the associated autoencoder components.

In some embodiments, the method 1100 may involve the base station being configured with information associated with autoencoder encoder adopted structure, autoencoder decoder adopted structure, autoencoder encoder weights, autoencoder decoder weights, autoencoder encoder structure, autoencoder decoder structure, channel state information bit stream generation, and decoding schemes.

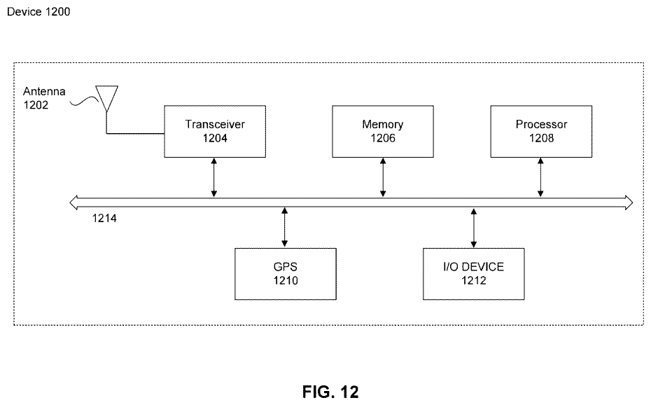

FIG. 12 is a block diagram of a device 1200, consistent with some embodiments of the present disclosure. The device 1200 can be a network node, a roadside unit, a relay node, a base station (e.g., base station 620 in FIG. 6 or base station 920 in FIG. 9) or a UE (e.g., UE 610 in FIG. 6 or UE 910 in FIG. 9). The device 1200 may take any form, including but not limited to, a computer system, a vehicle, a component mounted in a vehicle, a road-side unit, a laptop computer, a wireless terminal including a mobile phone, a wireless handheld device, or wireless personal device, or any other form. The device 1200 may include antenna 1202 that may be used for transmission or reception of electromagnetic signals to/from a base station, a UE, or other devices. The antenna 1202 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 1202 may include multiple (e.g., tens or hundreds) antenna elements and may enable multi-antenna functions such as beamforming. In some embodiments, the antenna 1202 is a single antenna.

The device 1200 may include a transceiver 1204 that is coupled to the antenna 1202. The transceiver 1204 may be a wireless transceiver at the device 1200 and may communicate bi-directionally with a base station, a UE, or other devices. For example, the transceiver 1204 (e.g., TX/RX module 680 or TX/RX module 685 in FIG. 6, or TX/RX module 990 or TX/RX module 995 in FIG. 9) may receive/transmit wireless signals from/to a UE or a gNB in Uu communications. The transceiver 1204 may include a modem to modulate the packets and provide the modulated packets to the antenna 1202 for transmission, and to demodulate packets received from the antenna 1202.

The device 1200 may include a memory 1206. The memory 1206 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 1206 may store information related to identities of device 1200 and the signals and/or data received by antenna 1202. The memory 1206 may also store post-processing signals and/or data. The memory 1206 may also store computer-readable program instructions, mathematical models, and algorithms that are used in signal processing in transceiver 1204 and computations in processor 1208. The memory 1206 may further store computer-readable program instructions for execution by processor 1208 to operate the device 1200 to perform various functions described in this disclosure. In some examples, the memory 1206 may include a basic input/output system (BIOS) which may control basic hardware or software operation such as the interaction with peripheral components or devices.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The device 1200 may include a processor 1208 that may include a hardware device with processing capabilities. The processor 1208 may include at least one of a general purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 1208 may be implemented using a combination of devices (e.g., a combination of a DSP and a microprocessor, multiple microprocessors, one or more microprocessors in conjunction with a DSP core, or any other such configuration). The processor 1208 may receive from transceiver 1204, downlink signals, uplink signals, reference signals and further process the signals. The processor 1208 may also receive from transceiver 1204, data packets and further process the packets. In some embodiments, the processor 1208 may be configured to operate a memory using a memory controller. In some embodiments, a memory controller may be integrated into the processor 1208. The processor 1208 may be configured to execute computer-readable instructions stored in a memory (e.g., the memory 1206) to cause the device 1200 to perform various functions.

The device 1200 may include a global positioning system (GPS) 1210. The GPS 1210 may be used for enabling location-based services or other services based on a geographical position of the device 1200. The GPS 1210 may receive global navigation satellite systems (GNSS) signals from a single satellite or a plurality of satellite signals via the antenna 1202 and provide a geographical position of the device 1200 (e.g., coordinates of the device 1200). In some embodiments, e.g., such as when the device 1200 may be a base station that is in a substantially fixed position, the GPS 1210 may be omitted.

The device 1200 may include an input/output (I/O) device 1212 that may be used to communicate a result of signal processing and computation to a user or another device. The I/O device 1212 may include a user interface including a display and an input device to transmit a user command to processor 1208. The display may be configured to display a status of signal reception at the device 1200, the data stored at memory 1206, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The device 1200 may further include a machine interface 1214, such as an electrical bus that connects the transceiver 1204, the memory 1206, the processor 1208, the GPS 1210, and the I/O device 1212.

In some embodiments, the device 1200 may be configured to or programmed for managing channel state information feedback compression. The processor 1208 may be configured to execute the instructions stored in memory 1206 to perform at least one of the methods 700, 800, 1000, or 1110 described in connection with FIGS. 7, 8, 10, and 11, respectively.

In some embodiments, the device 1200 may be configured to or programmed to transmit CSI over a Uu interface. For example, the device 1200 may be UE in a Uu interface communication, and the processor 1208 may be configured to execute the instructions stored in the memory 1206 to determine the channel state information; store the channel state information; and transmit, to a base station, the channel state information. The device 1200 may include any well-known elements of UE.

In some embodiments, the device 1200 may be a UE, and the processor 1208 may execute the instructions stored in the memory 1206 to: receive at least one reference signal; estimate a channel condition based on the at least one reference signal; reduce, using a first autoencoder encoder in UE, a dimension of the estimated channel condition such that a low dimension channel condition is generated; calculate, using a second autoencoder encoder and an autoencoder decoder in the UE, an error measurement based on a difference between UE channel state input and UE channel state output; and transmit a CSI bit stream, wherein the CSI bit stream is based on at least one of the low dimension channel condition or a value indicative of the error measurement.

In some embodiments, the device 1200 may be a base station (e.g., gNB), and the processor 1208 may execute the instructions stored in the memory 1206 to: transmit at least one reference signal; receive a channel state information bit stream in response to the transmitted at least one reference signal; determine at least one of a low dimension channel condition or a value indicative of an error measurement based on the CSI bit stream; calculate at least one of updated weights or updated parameters for an autoencoder decoder in a base station based on at least one of an estimated channel condition or the value indicative of the error measurement, wherein the estimated channel condition is based on the low dimension channel condition; and update at least one of weights or parameters of the autoencoder decoder in the base station based on the calculated at least one of updated weights or updated parameters.

One or more aspects of the present disclosure may relate to or otherwise incorporate features of “Study on AI/ML for NR Air Interface”in 3GPP Release 18.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware. In at least some embodiments consistent with the present disclosure, weights/parameters of the AE encoder and AE decoder are updated both at the UE side or at the gNB side.

Many variations other than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

While the example embodiments provided in this disclosure refer to 3GPP NR Radio Access Technology examples, the scope of the solutions in this disclosure are by no means limited to these examples. They can be applied, for example, to 3GPP LTE, or 3GPP 6G. They can be also applied to non-3GPP Radio Access Technologies, for example IEEE 802.11 technologies (for example but not limited to, 802.11n, 802.11u or 802.11p).

As used in this disclosure, use of the term “or” in a list of items indicates an inclusive list. The list of items may be prefaced by a phrase such as “at least one of’ or “one or more of’. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated in order to explain the nature of described embodiments may be made by those skilled in the art without departing from the scope. Accordingly, the following claims embrace all such alternatives, modifications and variations that fall within the terms of the claims.

Clause 1: A method of managing channel state information feedback compression, the method comprising:
receiving at least one reference signal;
estimating a channel condition based on the at least one reference signal;
reducing, using a first autoencoder encoder in user equipment (UE), a dimension of the estimated channel condition such that a low dimension channel condition is generated;
calculating, using a second autoencoder encoder and an autoencoder decoder in the UE, an error measurement based on a difference between UE channel state input and UE channel state output; and
transmitting at least one of a channel state information bit stream or at least one message, wherein the at least one of the channel state information bit stream or the at least one message is based on at least one of the low dimension channel condition or a value indicative of the error measurement.

Clause 2: The method of clause 1, further comprising:
generating the at least one of the channel state information bit stream or the at least one message based on at least one of the low dimension channel condition or the value indicative of the error measurement.

Clause 3: The method of clause 1, wherein the at least one reference signal is received from a base station.

Clause 4: The method of clause 1, wherein the at least one of the channel state information bit stream or the at least one message is transmitted to the base station.

Clause 5: The method of clause 4, wherein the at least one of the channel state information bit stream or the at least one message transmitted to the base station contains at least one of the low dimension channel condition or the value indicative of the error measurement.

Clause 6: The method of clause 1, wherein the first autoencoder encoder is based on a deep neural network.

Clause 7: The method of clause 6, wherein the deep neural network comprises a plurality of neural nodes, and each of the neural nodes comprises weights and parameters used to generate an output based on neural-node input.

Clause 8: The method of clause 1, further comprising inputting to the first autoencoder encoder the estimated channel condition, wherein the estimated channel condition input to the first autoencoder encoder is a high dimension channel condition.

Clause 9: The method of clause 1, wherein the calculating the error measurement based on a difference between UE channel state input and UE channel state output comprises using a loss function.

Clause 10: The method of clause 1, further comprising calculating updated weights and parameters for the first autoencoder encoder and the autoencoder decoder based on the error measurement.

Clause 11: The method of clause 1, further comprising receiving at least one of autoencoder encoder weights, autoencoder encoder parameters, autoencoder encoder structure, autoencoder decoder weights, autoencoder decoder parameters, or autoencoder decoder structure.

Clause 12: The method of clause 1, wherein the UE is configured with information associated with autoencoder encoder adopted structure, autoencoder decoder adopted structure, autoencoder encoder weights, autoencoder decoder weights, autoencoder encoder structure, autoencoder decoder structure, channel state information bit stream generation, and decoding schemes.

Clause 13: The method of clause 1, further comprising receiving at least one of autoencoder encoder structure or autoencoder decoder structure.

Clause 14: The method of clause 13, wherein the at least one of the autoencoder encoder structure or the autoencoder decoder structure is included in at least one of a master information block message or a system information block message.

Clause 15: An apparatus for channel state information feedback compression, the apparatus comprising:
a memory storing an instruction; and
a processor configured to execute the instruction stored in the memory to: receive at least one reference signal;
estimate a channel condition based on the at least one reference signal;
reduce, using a first autoencoder encoder in user equipment (UE), a dimension of the estimated channel condition such that a low dimension channel condition is generated;
calculate, using a second autoencoder encoder and an autoencoder decoder in the UE, an error measurement based on a difference between UE channel state input and UE channel state output; and
transmit at least one of a channel state information bit stream or at least one message, wherein the at least one of the channel state information bit stream or the at least one message is based on at least one of the low dimension channel condition or a value indicative of the error measurement.

Clause 16: The apparatus of clause 15, wherein the processor is further configured to execute the instruction stored in the memory to:
generate the at least one of the channel state information bit stream or the at least one message based on at least one of the low dimension channel condition or the value indicative of the error measurement.

Clause 17: The apparatus of clause 15, wherein the at least one reference signal is received from a base station.

Clause 18: The apparatus of clause 15, wherein the at least one of the channel state information bit stream or the at least one message is transmitted to the base station.

Clause 19: The apparatus of clause 18, wherein the at least one of the channel state information bit stream or the at least one message transmitted to the base station contains at least one of the low dimension channel condition or the value indicative of the error measurement.

Clause 20: The apparatus of clause 15, wherein the first autoencoder encoder is based on a deep neural network.

Clause 21: The apparatus of clause 20, wherein the deep neural network comprises a plurality of neural nodes, and each of the neural nodes comprises weights and parameters used to generate an output based on neural-node input.

Clause 22. The apparatus of clause 15, wherein the processor is further configured to execute the instruction stored in the memory to: input to the first autoencoder encoder the estimated channel condition, wherein the estimated channel condition input to the first autoencoder encoder is a high dimension channel condition.

Clause 23: The apparatus of clause 15, wherein the error measurement is calculated based on a difference between UE channel state input and UE channel state output comprises using a loss function.

Clause 24: The apparatus of clause 15, wherein the processor is further configured to execute the instruction stored in the memory to:
calculate updated weights and parameters for the first autoencoder encoder and the autoencoder decoder based on the error measurement.

Clause 25: The apparatus of clause 15, wherein the processor is further configured to execute the instruction stored in the memory to: receive at least one of autoencoder encoder weights, autoencoder encoder parameters, autoencoder encoder structure, autoencoder decoder weights, autoencoder decoder parameters, or autoencoder decoder structure.

Clause 26: The apparatus of clause 15, wherein the UE is configured with information associated with autoencoder encoder adopted structure, autoencoder decoder adopted structure, autoencoder encoder weights, autoencoder decoder weights, autoencoder encoder structure, autoencoder decoder structure, channel state information bit stream generation, and decoding schemes.

Clause 27: The apparatus of clause 15, the processor is further configured to execute the instruction stored in the memory to: receive at least one of autoencoder encoder structure or autoencoder decoder structure.

Clause 28: The apparatus of clause 27, wherein the at least one of the autoencoder encoder structure or the autoencoder decoder structure is included in at least one of a master information block message or a system information block message.

Clause 29: A non-transitory computer-readable medium storing instructions that are executable by one or more processors of an apparatus for managing channel state information feedback compression, to perform a method, the method comprising:
receiving at least one reference signal;
estimating a channel condition based on the at least one reference signal;
reducing, using a first autoencoder encoder in user equipment UE, a dimension of the estimated channel condition such that a low dimension channel condition is generated;
calculating, using a second autoencoder encoder and an autoencoder decoder in the UE, an error measurement based on a difference between UE channel state input and UE channel state output; and
transmitting at least one of a channel state information bit stream or at least one message, wherein the at least one of the channel state information bit stream or the at least one message is based on at least one of the low dimension channel condition or a value indicative of the error measurement.

Clause 30: A method of managing channel state information feedback compression, the method comprising:
transmitting at least one reference signal;
receiving at least one of a channel state information bit stream in response to the transmitted at least one reference signal, or at least one message;
determining at least one of a low dimension channel condition or a value indicative of an error measurement based on the at least one of the channel state information bit stream or the at least one message;
calculating at least one of updated weights or updated parameters for an autoencoder decoder in a base station based on at least one of an estimated channel condition or the value indicative of the error measurement, wherein the estimated channel condition is based on the low dimension channel condition; and
updating at least one of weights or parameters of the autoencoder decoder in the base station based on the calculated at least one of updated weights or updated parameters.

Clause 31: The method of clause 30, wherein the estimated channel condition is determined using the autoencoder decoder in the base station to decode the low dimension channel condition.

Clause 32: The method of clause 30, wherein the at least one reference signal is transmitted to user equipment (UE), and the at least one of the channel state information bit stream or the at least one message is received from the UE.

Clause 33: The method of clause 30, wherein determining at least one of the low dimension channel condition or the value indicative of the error measurement comprises extracting at least one of the low dimension channel condition or the value indicative of the error measurement from the at least one of the channel state information bit stream or the at least one message.

Clause 34: The method of clause 30, wherein the autoencoder decoder in the base station is based on a deep neural network.

Clause 35: The method of clause 34, wherein the deep neural network comprises a plurality of neural nodes, and each of the neural nodes comprises at least one of weights or parameters used to generate an output based on neural-node input.

Clause 36: The method of clause 30, further comprising converting the low dimension channel condition to a high dimension channel condition using the autoencoder decoder.

Clause 37: The method of clause 30, wherein calculating at least one of updated weights or updated parameters for the autoencoder decoder in the base station comprises calculating at least one of updated weights or updated parameters for the autoencoder decoder in the base station based on the value indicative of the error measurement.

Clause 38: The method of clause 37, wherein the at least one of updated weights or updated parameters for the autoencoder decoder correspond to at least one of updated weights or updated parameters for an autoencoder encoder in user equipment.

Clause 39: The method of clause 30, wherein calculating at least one of updated weights or updated parameters further includes calculating at least one of updated weights or updated parameters for each of a first autoencoder encoder in user equipment (UE), a second autoencoder encoder in the UE, and an autoencoder decoder in the UE, and wherein the second autoencoder encoder in the UE and the autoencoder decoder in the UE belong to the same autoencoder pair.

Clause 40: The method of clause 39, wherein calculating at least one of updated weights or updated parameters further includes updating at least one of weights or parameters for the first autoencoder encoder in the UE, for the second autoencoder encoder in the UE, and for the autoencoder decoder in the UE.

Clause 41: The method of clause 30, wherein the base station is configured with information associated with autoencoder encoder adopted structure, autoencoder decoder adopted structure, autoencoder encoder weights, autoencoder decoder weights, autoencoder encoder structure, autoencoder decoder structure, channel state information bit stream generation, and decoding schemes.

Clause 42: The method of clause 30, further comprising transmitting at least one of autoencoder encoder structure or autoencoder decoder structure to user equipment.

Clause 43: An apparatus for managing channel state information feedback
compression, the apparatus comprising:
a memory storing an instruction; and
a processor configured to execute the instruction stored in the memory to: transmit at least one reference signal;
receive at least one of a channel state information bit stream in response to the transmitted at least one reference signal, or at least one message;
determine at least one of a low dimension channel condition or a value indicative of an error measurement based on the at least one of the channel state information bit stream or the at least one message;
calculate at least one of updated weights or updated parameters for an autoencoder decoder in a base station based on at least one of an estimated channel condition or the value indicative of the error measurement, wherein the estimated channel condition is based on the low dimension channel condition; and
update at least one of weights or parameters of the autoencoder decoder in the base station based on the calculated at least one of updated weights or updated parameters.

Clause 44: The apparatus of clause 43, wherein the estimated channel condition is determined using the autoencoder decoder in the base station to decode the low dimension channel condition.

Clause 45: The apparatus of clause 43, wherein the at least one reference signal is transmitted to user equipment (UE), and the at least one of the channel state information bit stream or the at least one message is received from the UE.

Clause 46: The apparatus of clause 43, wherein determining at least one of the low dimension channel condition or the value indicative of the error measurement comprises extracting at least one of the low dimension channel condition or the value indicative of the error measurement from the at least one of the channel state information bit stream or the at least one message.

Clause 47: The apparatus of clause 43, wherein the autoencoder decoder in the base station is based on a deep neural network.

Clause 48: The apparatus of clause 47, wherein the deep neural network comprises a plurality of neural nodes, and each of the neural nodes comprises at least one of weights or parameters used to generate an output based on neural-node input.

Clause 49: The apparatus of clause 43, wherein the processor is further configured to execute the instruction stored in the memory to:
convert the low dimension channel condition to a high dimension channel condition using the autoencoder decoder.

Clause 50: The apparatus of clause 43, wherein calculating at least one of updated weights or updated parameters for the autoencoder decoder in the base station comprises calculating at least one of updated weights or updated parameters for the autoencoder decoder in the base station based on the value indicative of the error measurement.

Clause 51: The apparatus of clause 50, wherein the at least one of updated weights or updated parameters for the autoencoder decoder correspond to at least one of updated weights or updated parameters for an autoencoder encoder in user equipment.

Clause 52: The apparatus of clause 43, wherein calculating at least one of updated weights or updated parameters further includes calculating at least one of updated weights or updated parameters for each of a first autoencoder encoder in user equipment (UE), a second autoencoder encoder in the UE, and an autoencoder decoder in the UE, and wherein the second autoencoder encoder in the UE and the autoencoder decoder in the UE belong to the same autoencoder pair.

Clause 53: The apparatus of clause 52, wherein calculating at least one of updated weights or updated parameters further includes updating at least one of weights, parameters or structures for the first autoencoder encoder in the UE, for the second autoencoder encoder in the UE, and for the autoencoder decoder in the UE.

Clause 54: The apparatus of clause 43, wherein the base station is configured with information associated with autoencoder encoder adopted structure, autoencoder decoder adopted structure, autoencoder encoder weights, autoencoder decoder weights, autoencoder encoder structure, autoencoder decoder structure, channel state information bit stream generation, and decoding schemes.

Clause 55: The apparatus of clause 43, wherein the processor is further configured to execute the instruction stored in the memory to: transmit at least one of autoencoder encoder structure or autoencoder decoder structure to user equipment.

Clause 56: A non-transitory computer-readable medium storing instructions that are executable by one or more processors of an apparatus for managing channel state information feedback compression, to perform a method, the method comprising:
transmitting at least one reference signal;
receiving at least one of a channel state information bit stream in response to the transmitted at least one reference signal, or at least one message;
determining at least one of a low dimension channel condition or a value indicative of an error measurement based on the at least one of the channel state information bit stream or the at least one message;
calculating at least one of updated weights or updated parameters for an autoencoder decoder in a base station based on at least one of an estimated channel condition or the value indicative of the error measurement, wherein the estimated channel condition is based on the low dimension channel condition; and
updating at least one of weights or parameters of the autoencoder decoder in the base station based on the calculated at least one of updated weights or updated parameters.

Clause 57: A method of managing channel state information feedback compression, the method comprising:
receiving at least one reference signal;
estimating a channel condition based on the at least one reference signal;
reducing, using a first autoencoder encoder in user equipment (UE), a dimension of the estimated channel condition such that a low dimension channel condition is generated;
calculating, using a second autoencoder encoder and an autoencoder decoder in the UE, an error measurement based on a difference between UE channel state input and UE channel state output;
calculating at least one of updated weights or updated parameters for the first autoencoder encoder in the UE based on a value indicative of the error measurement;
updating at least one of weights or parameters of the first autoencoder encoder in the UE based on the calculated at least one of updated weights or updated parameters;
generating at least one of a channel state information bit stream or at least one message based on the at least one of the low dimension channel condition or at least one of updated weights or updated parameters of the first autoencoder encoder in the UE; and
transmitting the at least one of the channel state information bit stream or the at least one message.

Clause 58. The method of clause 57, further comprising:
calculating at least one of updated weights or updated parameters for an autoencoder decoder in a base station based on the value indicative of the error measurement; and
transmitting, to the base station, the at least one of updated weights or updated parameters for the autoencoder decoder in the base station.

Clause 59: The method of clause 57, further comprising transmitting information relating to at least one of the first autoencoder encoder in the UE, the second autoencoder encoder in the UE, the autoencoder decoder in the UE, an autoencoder decoder in a base station, or calculated weights, parameters or structures of at least one of the first autoencoder encoder in the UE, the second autoencoder encoder in the UE, the autoencoder decoder in the UE, or the autoencoder decoder in the base station.

Clause 60: The method of clause 59, further comprising receiving a response including a confirmation including the calculated weights, parameters or structures of at least one of the first autoencoder encoder in the UE, the second autoencoder encoder in the UE, the autoencoder decoder in the UE, or the autoencoder decoder in the base station; and based on the confirmation, updating at least one of structure or the calculated weights or parameters of at least one of the first autoencoder encoder in the UE, the second autoencoder encoder in the UE, or the autoencoder decoder in the UE.

Clause 61: A method of managing channel state information feedback compression, the method comprising:
transmitting at least one reference signal;
receiving at least one of a channel state information bit stream in response to the transmitted at least one reference signal, or at least one message;
determining at least one of updated weights, updated parameters, or structure for at least one of a first autoencoder in a user equipment (UE), a second autoencoder in the UE or an autoencoder decoder in the UE;
calculating at least one of updated weights or updated parameters for an autoencoder decoder in a base station based on the at least one of the updated weights or the updated parameters for the autoencoder encoder in the UE; and
updating at least one of weights, parameters or structure of the autoencoder decoder in the base station based on the calculated at least one of updated weights or updated parameters or structure.

Clause 62: The method of clause 61, further comprising:
receiving, from the UE, at least one of calculated weights, parameters or updated structure for at least one of the autoencoder decoder in the base station, the first autoencoder encoder in the UE, the second autoencoder encoder in the UE, or the autoencoder decoder in the UE.

Clause 63: The method of clause 62, wherein the updated structure is a sandwich structure.

Clause64. The method of clause 61, further comprising transmitting, to the UE, at least one of calculated weights, parameters or structure for at least one of the autoencoder decoder in the base station, the first autoencoder encoder in the UE, the second autoencoder encoder in the UE, or the autoencoder decoder in the UE.

### LIST OF ABBREVIATIONS

3GPP Third Generation Partnership Project
AE Autoencoder
CSI Channel State Information
DL Downlink
gNB Base Station or Next Generation Base Station
LTE Long-Term Evolution
NR New Radio
PDU Protocol Data Unit
PSCCH Physical Sidelink Control Channel
PSSCH Physical Sidelink Shared Channel
RS Reference Signal
TX/RX Transmit / Receive
UE User Equipment
UL Uplink
Uu UMTS Air Interface

1. A method of managing channel state information feedback compression, the method comprising:
receiving at least one reference signal;
estimating a channel condition based on the at least one reference signal;
reducing, using a first autoencoder encoder in user equipment (UE), a dimension of the estimated channel condition such that a low dimension channel condition is generated;
calculating, using a second autoencoder encoder and an autoencoder decoder in the UE, an error measurement based on a difference between UE channel state input and UE channel state output; and
transmitting at least one of a channel state information bit stream or at least one message, wherein the at least one of the channel state information bit stream or the at least one message is based on at least one of the low dimension channel condition or a value indicative of the error measurement.

2. The method of claim 1, further comprising:
generating the at least one of the channel state information bit stream or the at least one message based on at least one of the low dimension channel condition or the value indicative of the error measurement.

3. The method of claim 1, wherein the at least one of the channel state information bit stream or the at least one message is transmitted to the base station.

4. The method of claim 1, wherein the first autoencoder encoder is based on a deep neural network.

5. The method of claim 1, further comprising inputting to the first autoencoder encoder the estimated channel condition, wherein the estimated channel condition input to the first autoencoder encoder is a high dimension channel condition.

6. The method of claim 1, wherein the calculating the error measurement based on a difference between UE channel state input and UE channel state output comprises using a loss function.

7. The method of claim 1, further comprising calculating updated weights and parameters for the first autoencoder encoder and the autoencoder decoder based on the error measurement.

8. The method of claim 1, further comprising receiving at least one of autoencoder encoder weights, autoencoder encoder parameters, autoencoder encoder structure, autoencoder decoder weights, autoencoder decoder parameters, or autoencoder decoder structure.

9. A method of managing channel state information feedback compression, the method comprising:
transmitting at least one reference signal;
receiving at least one of a channel state information bit stream in response to the transmitted at least one reference signal, or at least one message;
determining at least one of a low dimension channel condition or a value indicative of an error measurement based on the at least one of the channel state information bit stream or the at least one message;
calculating at least one of updated weights or updated parameters for an autoencoder decoder in a base station based on at least one of an estimated channel condition or the value indicative of the error measurement, wherein the estimated channel condition is based on the low dimension channel condition; and
updating at least one of weights or parameters of the autoencoder decoder in the base station based on the calculated at least one of updated weights or updated parameters.

10. The method of claim 9, wherein the estimated channel condition is determined using the autoencoder decoder in the base station to decode the low dimension channel condition.

11. The method of claim 9, wherein the at least one reference signal is transmitted to user equipment (UE), and the at least one of the channel state information bit stream or the at least one message is received from the UE.

12. The method of claim 9, wherein determining at least one of the low dimension channel condition or the value indicative of the error measurement comprises extracting at least one of the low dimension channel condition or the value indicative of the error measurement from the at least one of the channel state information bit stream or the at least one message.

13. The method of claim 9, wherein the autoencoder decoder in the base station is based on a deep neural network.

14. The method of claim 9, further comprising converting the low dimension channel condition to a high dimension channel condition using the autoencoder decoder.

15. The method of claim 9, wherein calculating at least one of updated weights or updated parameters for the autoencoder decoder in the base station comprises calculating at least one of updated weights or updated parameters for the autoencoder decoder in the base station based on the value indicative of the error measurement.

16. The method of claim 9, wherein calculating at least one of updated weights or updated parameters further includes calculating at least one of updated weights or updated parameters for each of a first autoencoder encoder in user equipment (UE), a second autoencoder encoder in the UE, and an autoencoder decoder in the UE, and wherein the second autoencoder encoder in the UE and the autoencoder decoder in the UE belong to the same autoencoder pair.

17. A method of managing channel state information feedback compression, the method comprising:
receiving at least one reference signal;
estimating a channel condition based on the at least one reference signal;
reducing, using a first autoencoder encoder in user equipment (UE), a dimension of the estimated channel condition such that a low dimension channel condition is generated;
calculating, using a second autoencoder encoder and an autoencoder decoder in the UE, an error measurement based on a difference between UE channel state input and UE channel state output;
calculating at least one of updated weights or updated parameters for the first autoencoder encoder in the UE based on a value indicative of the error measurement;
updating at least one of weights or parameters of the first autoencoder encoder in the UE based on the calculated at least one of updated weights or updated parameters;
generating at least one of a channel state information bit stream or at least one message based on the at least one of the low dimension channel condition or at least one of updated weights or updated parameters of the first autoencoder encoder in the UE; and
transmitting the at least one of the channel state information bit stream or the at least one message.

18. The method of claim 17, further comprising:
calculating at least one of updated weights or updated parameters for an autoencoder decoder in a base station based on the value indicative of the error measurement; and
transmitting, to the base station, the at least one of updated weights or updated parameters for the autoencoder decoder in the base station.

19. The method of claim 17, further comprising transmitting information relating to at least one of the first autoencoder encoder in the UE, the second autoencoder encoder in the UE, the autoencoder decoder in the UE, an autoencoder decoder in a base station, or calculated weights, parameters or structures of at least one of the first autoencoder encoder in the UE, the second autoencoder encoder in the UE, the autoencoder decoder in the UE, or the autoencoder decoder in the base station.

20. A method of managing channel state information feedback compression, the method comprising:
transmitting at least one reference signal;
receiving at least one of a channel state information bit stream in response to the transmitted at least one reference signal, or at least one message;
determining at least one of updated weights, updated parameters, or structure for at least one of a first autoencoder in a user equipment (UE), a second autoencoder in the UE or an autoencoder decoder in the UE;
calculating at least one of updated weights or updated parameters for an autoencoder decoder in a base station based on the at least one of the updated weights or the updated parameters for the autoencoder encoder in the UE; and
updating at least one of weights, parameters or structure of the autoencoder decoder in the base station based on the calculated at least one of updated weights or updated parameters or structure.
